(19) United States
(12) Patent Application Publication
(10) Pub. No.: US 2016/0227479 A1
(43) Pub. Date: Aug. 4, 2016

(54) METHOD AND CORRESPONDING APPARATUS AND SYSTEM FOR COOPERATIVE PROCESSING OF WIRELESS DATA

(71) Applicant: Huawei Technologies Co., Ltd., Shenzhen (CN)

(72) Inventor: Fuwei Ma, Shenzhen (CN)

(21) Appl. No.: 15/092,411

(22) Filed: Apr. 6, 2016

Related U.S. Application Data
(63) Continuation of application No. PCT/CN2014/074630, filed on Apr. 2, 2014.

(30) Foreign Application Priority Data
Oct. 16, 2013 (CN) 201310485419.6

(51) Int. Cl. H04W 48/16; H04W 72/04; H04L 5/00

(52) U.S. Cl. CPC H04W 48/16; H04L 5/0057; H04W 72/0426

(57) ABSTRACT

This embodiment of the present disclosure discloses a method for cooperative processing of wireless data, and further discloses an apparatus and a system for cooperative processing of wireless data, and a terminal interconnection apparatus. The method includes: sending, by a first terminal accessing a wireless communications network, a downlink radio channel parameter to a second terminal, so that the second terminal receives data according to the downlink radio channel parameter (including a carrier frequency, a timeslot number, and a modulation mode); or sending, by a first terminal, an uplink radio channel parameter (including a carrier frequency, a timeslot number, and a modulation mode) to a second terminal, so that the second terminal sends data according to the uplink radio channel parameter. By means of the present disclosure, multiple terminals can share a same radio channel to receive and send data in an innovative terminal networking manner.

### CROSS-REFERENCE TO RELATED APPLICATIONS

This application is a continuation of International Application No. PCT/CN2014/074630, filed on Apr. 2, 2014, which claims priority to Chinese Patent Application No. 201310485419.6, filed on Oct. 16, 2013, both of which are hereby incorporated by reference in their entireties.

### TECHNICAL FIELD

The present disclosure relates to the field of communications technologies, and in particular, to a method and a corresponding apparatus and system for cooperative processing of wireless data.

### BACKGROUND

In the prior art, generally only a terminal that establishes a radio channel connection to a base station can receive wireless data from the base station. That is, the terminal can receive wireless data from the base station only when an identity (ID) that can be identified by a network is configured on the terminal, for example, a subscriber identity module (SIM) card is installed in the terminal.

As the terminal market develops, due to shape or volume limitations of some terminals (for example, a wearable device), it is possible that a SIM card cannot be installed in these terminals, but these terminals still have a requirement of accessing a wireless communications network. However, a conventional communication manner obviously cannot satisfy such a requirement.

In addition, there is a case in which multiple terminals in close proximity simultaneously download same data from a same base station in many scenarios. For example, in a scenario of cooperative multimedia playing, multiple terminals need to download same media data to perform cooperative multimedia playing. In this case, if the conventional communication manner is used, the terminals need to independently use different downlink air interface (air interface for short) channels, which results in high overheads in aspects of resource scheduling and power consumption, and excessively low usage of physical resource blocks (PRB) when each user performs a small quantity of real-time services within a fixed period.

### SUMMARY

To resolve the technical problems, embodiments of the present disclosure provide a method and a corresponding apparatus and system for cooperative processing of wireless data, to resolve limitations of receiving and sending data by using a radio channel by a terminal in the prior art.

To resolve the foregoing technical problem, according to a first aspect, a method for cooperative processing of wireless data is provided, including:

accessing, by a first terminal, a wireless communications network; and

sending, by the first terminal, a downlink radio channel parameter to a second terminal, so that the second terminal receives, by using a downlink radio channel, data according to the downlink radio channel parameter, where the downlink radio channel parameter includes a carrier frequency, a timeslot number, and a modulation mode; or

sending, by the first terminal, an uplink radio channel parameter to the second terminal, so that the second terminal sends, by using an uplink radio channel, data according to the uplink radio channel parameter, where the uplink radio channel parameter includes a carrier frequency, a timeslot number, and a modulation mode.

As a first possible implementation manner of the first aspect, the sending, by the first terminal, a downlink radio channel parameter to a second terminal includes: periodically sending, by the first terminal, a data channel parameter to the second terminal, so that the second terminal receives, by using a data channel, the data according to the data channel parameter; or sending, by the first terminal, a control channel parameter to the second terminal at a time, so that the second terminal receives, by using a control channel, control information according to the control channel parameter, and decodes the control information to obtain a data channel parameter, so as to receive, by using a data channel, the data according to the data channel parameter.

As a second possible implementation manner of the first aspect, after the sending, by the first terminal, a downlink radio channel parameter to a second terminal, the method further includes: receiving, by the first terminal by using the downlink radio channel, the data according to the downlink radio channel parameter.

With reference to the second possible implementation manner of the first aspect, a third possible implementation manner of the first aspect is further provided, where after the sending, by the first terminal, a downlink radio channel parameter to a second terminal, the method further includes: receiving, by the first terminal, summary data sent by the second terminal, where the summary data includes demodulated data, decoded data, or data obtained after unpacking processing that is received by using the downlink radio channel by the second terminal; and performing, by the first terminal, data merging processing according to the summary data and the data that is received by using the downlink radio channel by the first terminal, where a manner of the data merging processing is at least one of the following: data merging at a demodulated data layer, data merging at a decoded data layer, or data packet merging.

With reference to the second possible implementation manner of the first aspect, a fourth possible implementation manner of the first aspect is further provided, where after the sending, by the first terminal, a downlink radio channel parameter to a second terminal, the method further includes: sending, by the first terminal, summary data to the second terminal, so that the second terminal performs data merging processing according to the summary data and the data that is received by using the downlink radio channel by the second terminal, where the summary data includes demodulated data, decoded data, or data obtained after unpacking processing that is received by using the downlink radio channel by the first terminal, and a manner of the data merging processing is at least one of the following: data merging at a demodulated data layer, data merging at a decoded data layer, or data packet merging.

With reference to the first aspect or the first possible implementation manner of the first aspect, a fifth possible implementation manner of the first aspect is further provided, where the first terminal sends the downlink radio channel parameter to the second terminal in the following manner: exchanging identification information and negotiating a data encryption mode, by the first terminal, with the second terminal by using a data transmission link established between the first terminal and the second terminal; and sending, by the first terminal by using the data transmission link, the downlink radio channel parameter to the second terminal according to the identification information of the second terminal and the negotiated data encryption mode.

With reference to the second, third or fourth possible implementation manner of the first aspect, a sixth possible implementation manner of the first aspect is further provided, where the method further includes: reporting, by the first terminal, a channel quality indicator (CQI) according to channel received quality of all terminals that receive the data by using the downlink radio channel, so that a base station allocates, on a subsequent radio frame, a radio resource to the first terminal with reference to the CQI.

According to a second aspect, a method for cooperative processing of wireless data is provided, including:

receiving, by a second terminal, a downlink radio channel parameter that is sent by a first terminal accessing a wireless communications network, and receiving, by using a downlink radio channel, data according to the downlink radio channel parameter, where the downlink radio channel parameter includes a carrier frequency, a timeslot number, and a modulation mode; or

receiving, by the second terminal, an uplink radio channel parameter sent by the first terminal, and sending, by using an uplink radio channel, data according to the uplink radio channel parameter, where the uplink radio channel parameter includes a carrier frequency, a timeslot number, and a modulation mode.

As a first possible implementation manner of the second aspect, the receiving, by a second terminal, a downlink radio channel parameter sent by the first terminal includes: periodically receiving, by the second terminal, a data channel parameter sent by the first terminal, and receiving, by using a data channel, the data according to the data channel parameter; or receiving, by the second terminal at a time, a control channel parameter sent by the first terminal, receiving, by using a control channel, control information according to the control channel parameter, decoding the control information to obtain a data channel parameter, and receiving, by using a data channel, the data according to the data channel parameter.

With reference to the second aspect or the first possible implementation manner of the second aspect, a second possible implementation manner of the second aspect is further provided, where the second terminal receives, in the following manner, the downlink radio channel parameter sent by the first terminal: exchanging identification information and negotiating a data encryption mode, by the second terminal, with the first terminal by using a data transmission link established between the second terminal and the first terminal, so that the first terminal sends, by using the data transmission link, the downlink radio channel parameter to the second terminal according to the identification information of the second terminal and the negotiated data encryption mode; and receiving, by the second terminal, the downlink radio channel parameter by using the data transmission link.

With reference to the second aspect or the first possible implementation manner of the second aspect, a third possible implementation manner of the second aspect is further provided, where after the receiving, by a second terminal, a downlink radio channel parameter sent by the first terminal, the method further includes: sending, by the second terminal, summary data to the first terminal, so that the first terminal performs data merging processing according to the summary data and the data that is received by using the downlink radio channel by the first terminal, where the summary data includes demodulated data, decoded data, or data obtained after unpacking processing that is received by using the downlink radio channel by the second terminal, and a manner of the data merging processing is at least one of the following: data merging at a demodulated data layer, data merging at a decoded data layer, or data packet merging.

With reference to the second aspect or the first possible implementation manner of the second aspect, a fourth possible implementation manner of the second aspect is further provided, where after the receiving, by a second terminal, a downlink radio channel parameter sent by the first terminal, the method further includes: receiving, by the second terminal, summary data sent by the first terminal, where the summary data includes demodulated data, decoded data, or data obtained after unpacking processing that is received by using the downlink radio channel by the first terminal; and performing, by the second terminal, data merging processing according to the summary data and the data that is received by using the downlink radio channel by the second terminal, where a manner of the data merging processing is at least one of the following: data merging at a demodulated data layer, data merging at a decoded data layer, or data packet merging.

According to a third aspect, an apparatus for cooperative processing of wireless data is provided, including:

a communications network access module, configured to access a wireless communications network, and at least one of the following modules:

a first parameter sending module, configured to send a downlink radio channel parameter to a second terminal, so that the second terminal receives, by using a downlink radio channel, data according to the downlink radio channel parameter, where the downlink radio channel parameter includes a carrier frequency, a timeslot number, and a modulation mode; and

a second parameter sending module, configured to send an uplink radio channel parameter to the second terminal, so that the second terminal sends, by using an uplink radio channel, data according to the uplink radio channel parameter, where the uplink radio channel parameter includes a carrier frequency, a timeslot number, and a modulation mode.

As a first possible implementation manner of the third aspect, the first parameter sending module includes:

a first sending unit, configured to periodically send a data channel parameter to the second terminal, so that the second terminal receives, by using a data channel, the data according to the data channel parameter; or a second sending unit, configured to send a control channel parameter to the second terminal at a time, so that the second terminal receives, by using a control channel, control information according to the control channel parameter, and decodes the control information to obtain a data channel parameter, so as to receive, by using a data channel, the data according to the data channel parameter.

As a second possible implementation manner of the third aspect, the apparatus further includes: a communications network data receiving module, configured to receive, by using the downlink radio channel, the data according to the downlink radio channel parameter.

With reference to the second possible implementation manner of the third aspect, a third possible implementation manner of the third aspect is further provided, where the apparatus further includes: a summary data receiving module, configured to receive summary data sent by the second terminal, where the summary data includes demodulated data, decoded data, or data obtained after unpacking processing that is received by using the downlink radio channel by the second terminal; and a data merging processing module, configured to perform data merging processing according to the summary data and the data that is received by using the downlink radio channel by the communications network data receiving module, where a manner of the data merging processing is at least one of the following: data merging at a demodulated data layer, data merging at a decoded data layer, or data packet merging.

With reference to the second possible implementation manner of the third aspect, a fourth possible implementation manner of the third aspect is further provided, where the apparatus further includes: a summary data sending module, configured to send summary data to the second terminal, so that the second terminal performs data merging processing according to the summary data and the data that is received by using the downlink radio channel by the second terminal, where the summary data includes demodulated data, decoded data, or data obtained after unpacking processing that is received by using the downlink radio channel by the communications network data receiving module, and a manner of the data merging processing is at least one of the following: data merging at a demodulated data layer, data merging at a decoded data layer, or data packet merging.

With reference to the third aspect or the first possible implementation manner of the third aspect, a fifth possible implementation manner of the third aspect is further provided, where the apparatus further includes: a link establishment module, configured to establish a data transmission link to the second terminal; and a cooperative negotiation module, configured to exchange identification information and negotiate a data encryption mode with the second terminal by using the data transmission link, where the first parameter sending module sends, by using the data transmission link, the downlink radio channel parameter to the second terminal according to the identification information of the second terminal and the negotiated data encryption mode.

With reference to the second, third or fourth possible implementation manner of the third aspect, a sixth possible implementation manner of the third aspect is further provided, where the apparatus further includes: a channel quality reporting module, configured to report a channel quality indicator CQI according to channel received quality of all terminals that receive the data by using the downlink radio channel, so that a base station allocates, on a subsequent radio frame, a radio resource to the first terminal with reference to the CQI.

According to a fourth aspect, an apparatus for cooperative processing of wireless data is provided, including:

a first parameter processing module, configured to receive a downlink radio channel parameter that is sent by a first terminal accessing a wireless communications network, and receive, by using a downlink radio channel, data according to the downlink radio channel parameter, where the downlink radio channel parameter includes a carrier frequency, a timeslot number, and a modulation mode; or

a second parameter processing module, configured to receive an uplink radio channel parameter sent by the first terminal, and send, by using an uplink radio channel, data according to the uplink radio channel parameter, where the uplink radio channel parameter includes a carrier frequency, a timeslot number, and a modulation mode.

As a first possible implementation manner of the fourth aspect, the first parameter processing module includes:

a first receiving unit, configured to periodically receive a data channel parameter sent by the first terminal; and a first processing unit, configured to receive, by using a data channel, the data according to the data channel parameter.

As a second possible implementation manner of the fourth aspect, the first parameter processing module includes: a second receiving unit, configured to receive, at a time, a control channel parameter sent by the first terminal; and a second processing unit, configured to receive, by using a control channel, control information according to the control channel parameter, decode the control information to obtain a data channel parameter, and receive, by using a data channel, the data according to the data channel parameter.

With reference to the fourth aspect or the first or second possible implementation manner of the fourth aspect, a third possible implementation manner of the fourth aspect is further provided, where the apparatus further includes: a link establishment module, configured to establish a data transmission link to the first terminal; and a cooperative negotiation module, configured to exchange identification information and negotiate a data encryption mode with the first terminal by using the data transmission link, so that the first terminal sends, by using the data transmission link, the downlink radio channel parameter to the first parameter processing module according to the identification information of the apparatus and the negotiated data encryption mode, where the first parameter processing module receives the downlink radio channel parameter by using the data transmission link.

With reference to the fourth aspect or the first or second possible implementation manner of the fourth aspect, a fourth possible implementation manner of the fourth aspect is further provided, where the apparatus further includes: a summary data sending module, configured to send summary data to the first terminal, so that the first terminal performs data merging processing according to the summary data and the data that is received by using the downlink radio channel by the first terminal, where the summary data includes demodulated data, decoded data, or data obtained after unpacking processing that is received by using the downlink radio channel by the first parameter processing module, and a manner of the data merging processing is at least one of the following: data merging at a demodulated data layer, data merging at a decoded data layer, or data packet merging.

With reference to the fourth aspect or the first or second possible implementation manner of the fourth aspect, a fifth possible implementation manner of the fourth aspect is further provided, where the apparatus further includes: a summary data receiving module, configured to receive summary data sent by the first terminal, where the summary data includes demodulated data, decoded data, or data obtained after unpacking processing that is received by using the downlink radio channel by the first terminal; and a data merging processing module, configured to perform data merging processing according to the summary data and the data that is received by using the downlink radio channel by the first parameter processing module, where a manner of the data merging processing is at least one of the following: data merging at a demodulated data layer, data merging at a decoded data layer, or data packet merging.

According to a fifth aspect, a system for cooperative processing of wireless data is provided, where the system includes:

the apparatus for cooperative processing of wireless data according to the third aspect of the present disclosure, and at least one apparatus for cooperative processing of wireless data according to the fourth aspect of the present disclosure.

According to a sixth aspect, a terminal interconnection apparatus is provided, including:

a data interface configured to establish a communication connection to a terminal;

a connection module, configured to establish a communication connection between the data interface and a control center module; and

the control center module, configured to access a wireless communications network, exchange identification information and negotiate a data encryption mode with a terminal on the data interface, and send an uplink radio channel parameter/a downlink radio channel parameter to the terminal on the data interface according to the identification information of the terminal on the data interface and the negotiated data encryption mode, so that the terminal on the data interface sends/receives data according to the uplink radio channel parameter/downlink radio channel parameter.

As a first possible implementation manner of the sixth aspect, the control center module is further configured to:

receive, by using the connection module, summary data that is sent by the terminal on the data interface, where the summary data includes demodulated data, decoded data, or data obtained after unpacking processing that is received by using the downlink radio channel by the terminal on the data interface; and

perform data merging processing according to the summary data, where a manner of the data merging processing is at least one of the following: data merging at a demodulated data layer, data merging at a decoded data layer, or data packet merging.

The implementation of the embodiments of the present disclosure has the following beneficial effects:

1) A first terminal and a second terminal can receive or send data by using a same radio channel, which can reduce, especially when there are multiple second terminals, resource scheduling overheads that are generated when an excessively large quantity of users are online simultaneously, and improve PRB usage when each user performs a small quantity of real-time services within a fixed period. Therefore, a service overload problem caused by an excessively large quantity of users is resolved without changing a network protocol.

2) From the perspective of an access fee, an access right and an access fee of only the first terminal need to be maintained, and the second terminal does not need to pay.

3) If data summarization processing is performed, for example, demodulated data is summarized for joint error correction decoding, effects of data error correction enhancement, and voice/audio quality enhancement can be achieved.

4) In some scenarios, the first terminal may be used as only a forwarding device for the second terminal to communicate with a base station. Therefore, a volume, an appearance, and the like of the first terminal may be tremendously simplified, and the second terminal needs to only perform near-field communication with the first terminal and does not need to communicate with the base station, which greatly reduces power consumption, and improves battery endurance.

5) In some scenarios, even if the second terminal does not access the wireless communications network (for example, a SIM card cannot be installed in the second terminal due to shape and volume limitations), the second terminal can also communicate with the base station by using uplink and downlink radio channel parameters sent by the first terminal.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1A is a schematic flowchart of a method for cooperative processing of wireless data according to an embodiment of the present disclosure;

FIG. 1B is a schematic diagram of separately allocating different timeslot resources to multiple terminals in the prior art;

FIG. 1C is another schematic diagram of separately allocating different timeslot resources to multiple terminals in the prior art;

FIG. 1D is a schematic diagram in which multiple terminals share a same timeslot to receive data according to an embodiment of the present disclosure;

FIG. 1E is a schematic diagram in which multiple terminals simultaneously receive data by using a same channel and perform data merging processing according to an embodiment of the present disclosure;

FIG. 1F is a schematic diagram in which multiple terminals send, by using a same channel, data according to an embodiment of the present disclosure;

FIG. 2A is a schematic flowchart of a method for cooperatively receiving wireless data according to an embodiment of the present disclosure;

FIG. 2B is a schematic diagram of a hierarchy of data merging according to an embodiment of the present disclosure;

FIG. 2C is a schematic flowchart of a method for cooperatively sending wireless data according to an embodiment of the present disclosure;

FIG. 3 is a schematic flowchart of a method for cooperative processing of wireless data according to an embodiment of the present disclosure;

FIG. 4A is a schematic block diagram of a cooperative processing apparatus according to an embodiment of the present disclosure;

FIG. 4B is a schematic block diagram of a cooperative processing apparatus according to an embodiment of the present disclosure;

FIG. 4C is a schematic block diagram of a cooperative processing apparatus according to an embodiment of the present disclosure;

FIG. 5A is a schematic block diagram of a cooperative processing apparatus according to an embodiment of the present disclosure;

FIG. 5B is a schematic block diagram of a cooperative processing apparatus according to an embodiment of the present disclosure;

FIG. 6 is a schematic block diagram of a system for cooperative processing of wireless data according to an embodiment of the present disclosure;

FIG. 7A is a schematic block diagram of a terminal interconnection apparatus according to an embodiment of the present disclosure;

FIG. 7B is a schematic diagram of a terminal interconnection apparatus according to an embodiment of the present disclosure;

FIG. 8 is a schematic block diagram of a cooperative processing apparatus according to an embodiment of the present disclosure; and

FIG. 9 is a schematic block diagram of a cooperative processing apparatus according to an embodiment of the present disclosure.

### DETAILED DESCRIPTION

The following clearly describes the technical solutions in the embodiments of the present disclosure with reference to the accompanying drawings in the embodiments of the present disclosure. Apparently, the described embodiments are merely some but not all of the embodiments of the present disclosure. All other embodiments obtained by a person of ordinary skill in the art based on the embodiments of the present disclosure without creative efforts shall fall within the protection scope of the present disclosure.

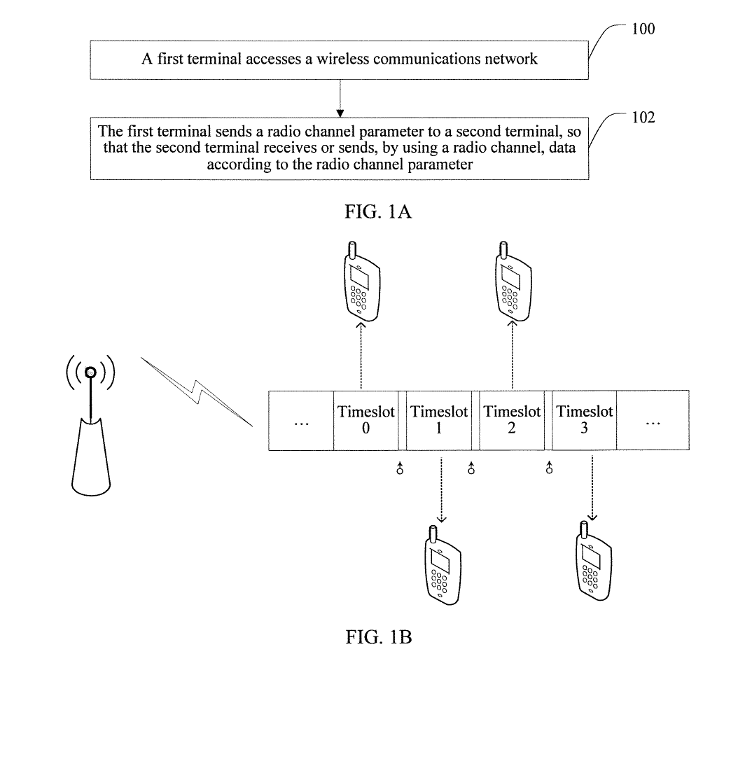

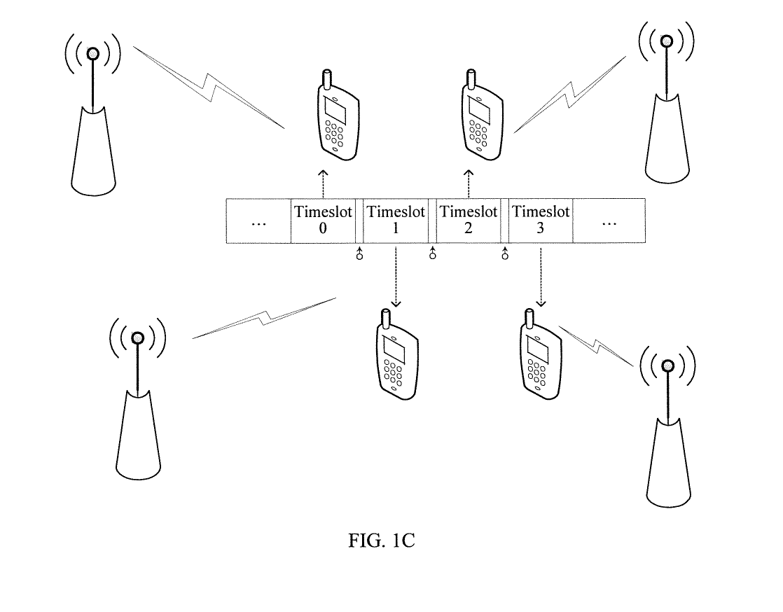

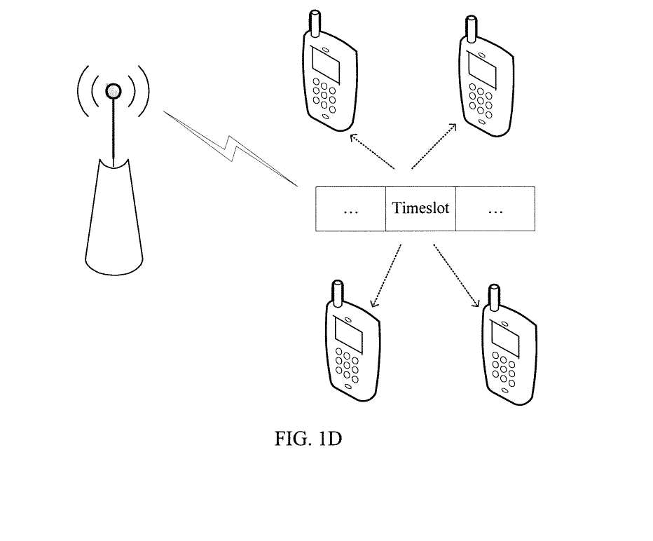

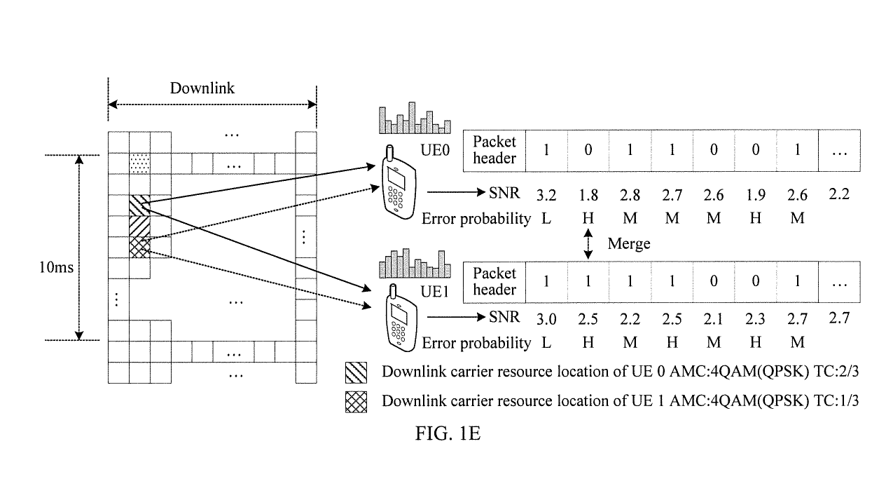

FIG. 1A is a schematic flowchart of a method for cooperative processing of wireless data according to an embodiment of the present disclosure. Referring to FIG. 1A, the method includes:

100: A first terminal accesses a wireless communications network.

Exemplarily, the first terminal establishes a radio channel connection to a base station, and the first terminal may perform data receiving/sending processing with the base station. For example, when the first terminal and another terminal need to perform cooperative multimedia playing, the first terminal may receive data; or when the first terminal is used as a remote communications module, the first terminal needs to only forward a radio channel parameter to another terminal and does not need to receive/send data.

102: The first terminal sends a radio channel parameter to a second terminal, so that the second terminal receives or sends, by using a radio channel, data according to the radio channel parameter.

In this embodiment, the second terminal has a capability of accessing a wireless communications network same as that accessed by the first terminal, for example, a capability of accessing the following networks: a Global System for Mobile Communications (GSM), a Universal Mobile Telecommunications System (UTMS), a Long Term Evolution (LTE) network, and a wireless local area network (WLAN) that is integrated into a base station as an addition to an access network. More specifically, the second terminal may have a data receiving module of a corresponding network, but a SIM card does not need to be installed in the second terminal. Optionally, the first terminal may exchange network access capability information with the second terminal, so as to determine whether the terminals can access a same wireless communications network.

Optionally, in an implementation manner of this embodiment, in step 102, the radio channel parameter is sent in the following manner: exchanging identification information (for example, a device number) and negotiating a data encryption mode, by the first terminal, with the second terminal by using a data transmission link established between the first terminal and the second terminal; and then sending, by the first terminal by using the data transmission link, the radio channel parameter to the second terminal according to the identification information of the second terminal and the negotiated data encryption mode. The data transmission connection may be a manner of communication, for example, Bluetooth, an infrared connection, a WLAN, Wi-Fi (Wireless Fidelity), Near Field Communication (NFC), or human body communication.

Optionally, in an implementation manner of this embodiment, step 102 includes: sending, by the first terminal, an uplink radio channel parameter to the second terminal, so that the second terminal sends, by using an uplink radio channel, data according to the uplink radio channel parameter, where the uplink radio channel parameter includes a carrier frequency, a timeslot number, and a modulation mode.

Optionally, in an implementation manner of this embodiment, step 102 includes: sending, by the first terminal, a downlink radio channel parameter to a second terminal, so that the second terminal receives, by using a downlink radio channel, the data according to the downlink radio channel parameter, where the downlink radio channel parameter includes a carrier frequency, a timeslot number, and a modulation mode.

The foregoing two optional implementation manners in this embodiment are described below with reference to FIG. 1B to FIG. 1F.

In a wireless network such as a GSM, WCDMA/CDMA2000, LTE/LTE-A, or Wi-Fi, a radio frame is divided into timeslots (Timeslot) of about 1 ms, and such a timeslot is used as a basic resource unit for allocation. As shown in FIG. 1B and FIG. 1C, according to the prior art, one downlink timeslot resource for transmitting user data can be allocated to and used by only one user terminal at a time, and cannot be allocated to and simultaneously used by multiple user terminals. However, according to this embodiment of the present disclosure, as shown in FIG. 1D, multiple user terminals may receive data from a same timeslot, and “cooperative receiving” mentioned in this application means collaboratively performing demodulation processing on these radio resource blocks that are allocated to user terminals.

A channel information parameter shared by multiple terminals may include: a cell ID (including a sector), a carrier, a timeslot, a receiving or sending indication, a modulation mode, a codec mode, or the like.

By using the cooperative receiving as an example, if multiple terminals want to receive data by using a same channel, one (for example, a first terminal) of the terminals needs to notify a currently used channel parameter (including a carrier frequency, a timeslot number, a modulation mode, or the like) to another terminal (for example, at least one second terminal), so that the multiple terminals collaboratively complete data receiving processing of this channel.

Referring to FIG. 1E, a base station allocates several resource units (as shown by small boxes in the figure) in a radio frame to a user terminal UE 0 for use. The UE 0 notifies a location (that is, a timeslot and a carrier) and an adaptive modulation and coding (AMC) of the resource unit to UE 1. Certainly, the UE 0 may further notify a channel parameter such as a channel encoding mode (TC) to the UE 1, so that the UE 1 performs processing such as demodulation or decoding according to the channel parameter.

The UE 0 needs to track, process, and demodulate a broadcast control channel and maintain an entire receiving processing procedure, while the UE 1 does not need to maintain an entire receiving processing procedure, and needs to only complete, according to the parameter provided by the UE 0, receiving processing such as demodulation of timeslot data. The UE 1 in this case may be considered as receive antenna diversity of the UE 0. Multiple user terminals of a group perform cooperative receiving and data enhancement processing when the user terminals are located at a sector border or a cell border, which can significantly improve network performance and experience of the user terminals, and also make receiving switching at the border much smoother.

Referring to FIG. 1E, the UE 0 and the UE 1 receive data by using a downlink channel, to obtain data bits with different signal-to-noise ratios, where the signal-to-noise ratio of each bit reflects whether a probability that an error occurs in this bit is large or small or is high or low. The data bits received by two terminals may be merged bit by bit, to obtain merged data with a lower bit error rate. For example, for the second received bit, a value received by the UE 0 is “0”, and a signal-to-noise ratio is 1.8, so that a probability that an error occurs is high; and a value received by the UE 1 is “1”, and a signal-to-noise ratio is 2.5, so that a probability that an error occurs is also relatively high. Comparing two signal-to-noise ratios, a probability that an error occurs of a decision “0” is lower than that of a decision of “1”. Therefore, decisions are finally merged into “0”, and these two signal-to-noise ratios are merged according to a decision value of “0”.

By using cooperative sending as an example, if multiple terminals want to send, by using a same channel, data to a base station, one (for example, a first terminal) of the terminals needs to notify a currently used uplink channel parameter (including a carrier frequency, a timeslot number, a modulation mode, and the like) to another terminal (for example, at least one second terminal), so that the multiple terminals collaboratively complete or one of the terminals independently completes data sending processing of this uplink channel.

Referring to FIG. 1F, UE 0 and UE 1 simultaneously send same data by using a same uplink channel, for example, an adaptive multirate codec (AMR) voice encoding bitstream is simultaneously sent. Important data (for example, AMR voice encoding Long Term Prediction (LTP) data) in a voice service bitstream may be simultaneously sent by more terminals by using a same channel, so as to ensure better sending quality. Same as that when the cooperative receiving is performed, the UE 0 notifies a location (that is, a timeslot and a carrier) and a channel modulation mode (AMC) of the resource unit to the UE 1. Certainly, the UE 0 may further notify a channel parameter such as a channel encoding mode (TC) to the UE 1.

The uplink radio channel parameter/downlink radio channel parameter that the base station delivers, by using a control channel, to the terminal for use may be updated in each radio frame. Therefore, these uplink radio channel parameters/downlink radio channel parameters may be obtained by using the control channel of the base station by at least one terminal, and are sent to another terminal, so as to help to perform cooperative receiving or sending.

This embodiment is applied to an LTE network as an example. Multiple terminals cooperatively receive a same LTE downlink timeslot, and a receiving gain similar to a receiving gain of multiple-input multiple-output (MIMO) may be obtained; and multiple terminals cooperatively send same transferred data in a same LTE uplink timeslot, and an impact of severe attenuation on uplink receiving may be avoided to a certain degree, so that a receiving gain similar to that of MIMO is obtained. One terminal located at the optimal position may be responsible for uplink sending of feedback information about channel quality, or one terminal is responsible for synchronizing multiple terminals to implement uplink MIMO sending. Specifically, for whether the uplink sending is completed by one terminal or by multiple terminals, a detailed decision control criterion may be set, for example, a criterion of minimum transmit power, a criterion of battery remaining energy, a principle of an auxiliary device (auxiliary enhanced antenna) priority, a criterion of minimum paid terminal power consumption, or a criterion that an external power supply bears power consumption, which resolves, to a certain degree, a usage defect that a smartphone has an excessively short standby time.

According to the method provided in this embodiment of the present disclosure, a mode for cooperative processing of wireless data is provided, so that a second terminal may receive or send data without accessing a wireless communications network, and the method provided in this embodiment of the present disclosure is applicable to many scenarios. Exemplarily, when multiple terminals located in a range of close proximity simultaneously download same data from a same base station, by means of the method provided in this embodiment of the present disclosure, resource scheduling overheads and power consumption overheads can be reduced, and physical resource block (PRB) usage can be improved. In addition, from the perspective of an access fee, a fee of at least one second terminal may be further reduced.

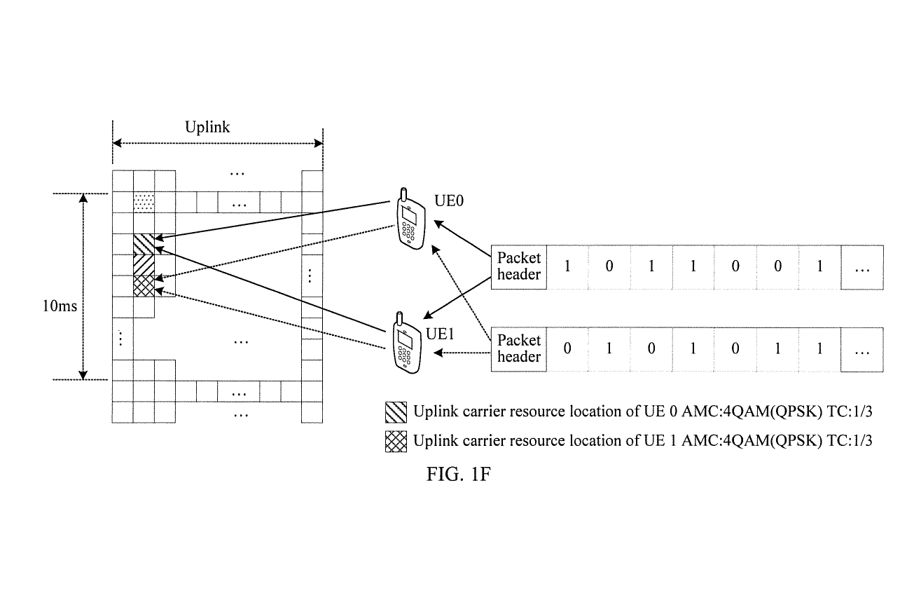

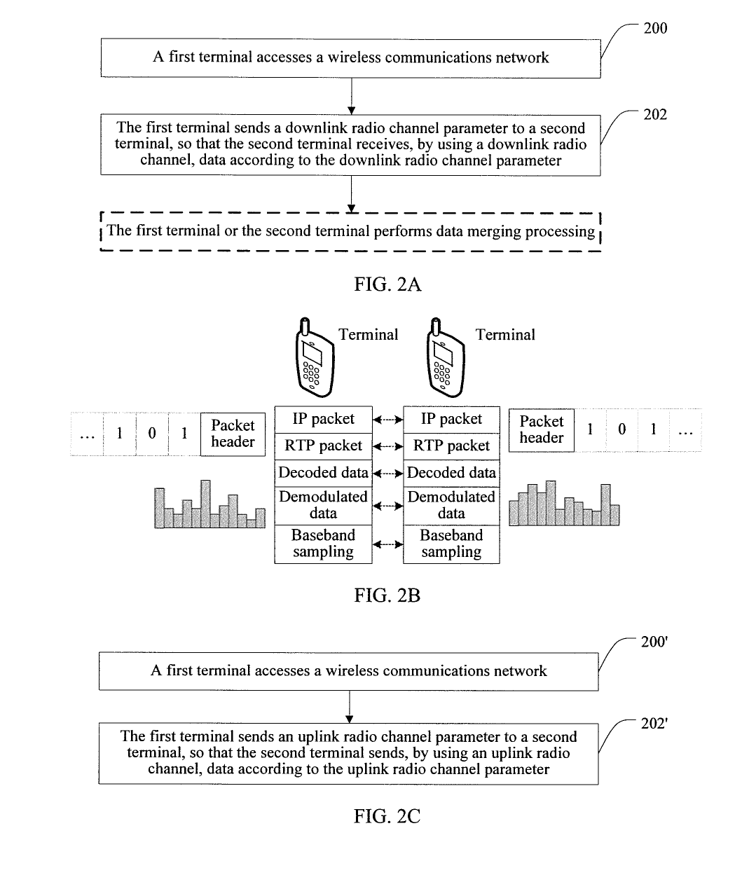

FIG. 2A is a schematic flowchart of a method for cooperatively receiving wireless data according to an embodiment of the present disclosure. Referring to FIG. 2A, the method includes:

200: A first terminal accesses a wireless communications network.

202: The first terminal sends a downlink radio channel parameter to a second terminal, so that the second terminal receives, by using a downlink radio channel, data according to the downlink radio channel parameter.

Optionally, in an implementation manner of this embodiment, the downlink radio channel parameter includes a data channel parameter or a control channel parameter. Specifically, in step 202, the first terminal may periodically send a data channel parameter to the second terminal, so that the second terminal receives, by using a data channel, the data according to the data channel parameter; or in step 202, the first terminal sends a control channel parameter to the second terminal at a time; in this way, the second terminal may receive, by using a control channel, control information according to the control channel parameter, and decode the control information to obtain a data channel parameter, so as to receive, by using a data channel, the data according to the data channel parameter.

Optionally, in an implementation manner of this embodiment, the first terminal further receives, by using the downlink radio channel, the data according to the downlink radio channel parameter.

In this case, as shown in FIG. 2A, the first terminal may perform data merging processing. For example, the first terminal receives summary data sent by the second terminal, where the summary data includes demodulated data, decoded data, or data obtained after unpacking processing that is received by using the downlink radio channel by the second terminal; and then, the first terminal performs data merging processing according to the summary data and the data that is received by using the downlink radio channel by the first terminal, where a manner of the data merging processing is at least one of the following: data merging at a demodulated data layer, data merging at a decoded data layer, or data packet merging.

Alternatively, in this case, as shown in FIG. 2A, the second terminal may perform data merging processing. For example, the first terminal sends summary data to the second terminal, so that the second terminal performs data merging processing according to the summary data and the data that is received by using the downlink radio channel by the second terminal, where the summary data includes demodulated data, decoded data, or data obtained after unpacking processing that is received by using the downlink radio channel by the first terminal, and a manner of the data merging processing is at least one of the following: data merging at a demodulated data layer, data merging at a decoded data layer, or data packet merging.

In fact, both the downlink radio channel parameter and the summary data may be sent between different layers, for example, the downlink radio channel parameter and the summary data may be sent on several layers such as baseband signal sampling data, demodulated data, channel decoded data, a Real-time Transport Protocol (Real-time Transport Protocol, RTP) packet, or an IP (Internet Protocol) packet that are shown in FIG. 2B. Correspondingly, data merging processing may include the following multiple selections: (1) selecting demodulated data for merging, where demodulated data of each carrier with a low bit error rate is selected as merged carrier demodulation output data according to a carrier signal-to-noise ratio of each receiving location, to constitute merged demodulated data for channel decoding; (2) selecting channel decoded data for merging, where an output soft value with a bit error rate is selected as a merged soft value according to soft values that are decoded and output by a channel of multiple terminals of each bit; (3) merging data packets, where comparison is performed to obtain differential bits of an output data packet of each receiving location and locations of the differential bits are marked; and if there are more than two receiving terminals, redundancy selection is performed, or if there are only two receiving terminals, marked positions are considered as bit error indication information for service bitstream decoding.

It should be understood by a person skilled in the art that when the first terminal does not receive, by using the downlink radio channel, the data according to the downlink radio channel parameter, if there are at least two second terminals, any terminal of the at least two second terminals may also receive the summary data and perform data merging processing.

Optionally, in an implementation manner of this embodiment, the first terminal reports a channel quality indicator CQI according to channel received quality of all terminals (for example, the first terminal and the second terminal) that receive the data by using the downlink radio channel, so that a base station allocates, on a subsequent radio frame, a radio resource to the first terminal with reference to the CQI. The channel received quality of the terminals may be determined by a terminal that performs data merging processing and according to the data received by the terminals. By using that the first terminal performs data merging processing as an example, the first terminal may perform the following analysis to determine the channel received quality of the terminals: each terminal receives same data, and data received on different layers are in different forms. For example, on a physical layer, a data bit obtained by means of demodulation is a probability value with a decision of “0” or “1”, and data obtained by means of decoding is a probability value after error correction, where if these probabilities are closer to “0” or “1”, a channel condition of this bit is more desirable, or if these probabilities are closer to a value which is closer to “0” or “1”, a channel condition of this bit is less desirable. Probability values of a same bit received by different terminals are compared, and probability values distributed in a more centralized way indicate closer channel conditions, where if probability values of a bit received by some terminals are close, and a probability value of a terminal has a relatively great deviation from the probability values, it indicates that a channel condition of the terminal having a probability value with a relatively great deviation is less desirable than those of the other devices. In an optional implementation manner, when reporting the CQI, the first terminal may simply select a highest CQI value of all receiving terminals of each carrier.

According to the method provided in this embodiment of the present disclosure, a data merging processing procedure is provided in a cooperative receiving processing process. Therefore, effects of data error correction enhancement, and voice/audio quality enhancement can be achieved. It should be understood by a person skilled in the art that some or all technical features recorded in this embodiment of the present disclosure may be combined with those of the embodiment shown in FIG. 1A.

FIG. 2C is a schematic flowchart of a method for cooperatively sending wireless data according to an embodiment of the present disclosure. Referring to FIG. 2C, the method includes:

200′: A first terminal accesses a wireless communications network.

202′: The first terminal sends an uplink radio channel parameter to a second terminal, so that the second terminal sends, by using an uplink radio channel, data according to the uplink radio channel parameter.

Optionally, in an implementation manner of this embodiment, after step 202′ step or 202′, the first terminal further sends, to the second terminal, data needing to be uploaded, so that the second terminal sends, according to the uplink radio channel parameter by using the uplink radio channel, the data needing to be uploaded. The data needing to be uploaded may be data that needs to be uploaded by the first terminal, or may be data that the first terminal receives from a third terminal and that needs to be uploaded by the third terminal (where “the first terminal”, “the second terminal”, and “the third terminal” are only to represent that terminals are independent of each other).

Obviously, a second terminal in this embodiment may upload data by using an uplink radio channel parameter of a first terminal without accessing a wireless communications network, in other words, when the data is uploaded, the first terminal may avoid uplink transmit power consumption and the power consumption is transferred to the second terminal, which provide a new terminal design probability and a terminal networking possibility to a person skilled in the art.

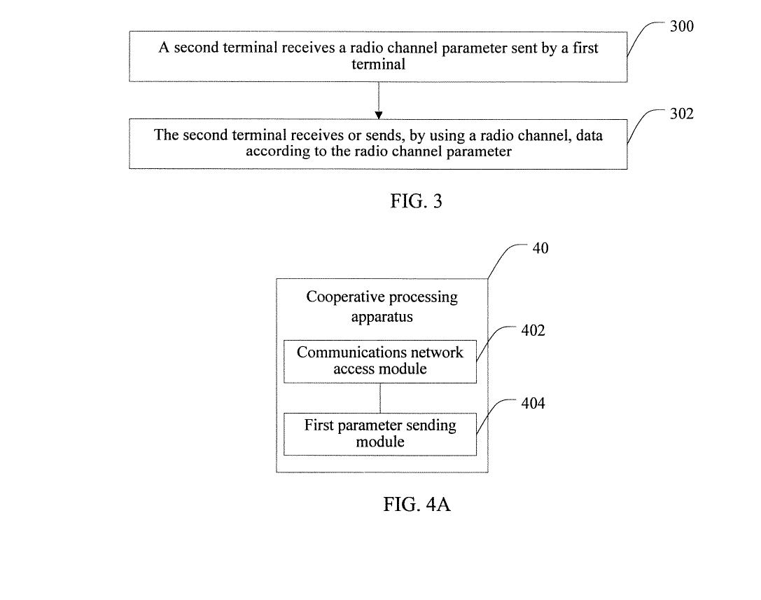

FIG. 3 is a schematic flowchart of a method for cooperative processing of wireless data according to an embodiment of the present disclosure. Referring to FIG. 3, the method includes:

300: A second terminal receives a radio channel parameter sent by a first terminal, where the first terminal already accesses a wireless communications network, and the second terminal has a capability of accessing a wireless communications network same as that accessed by the first terminal, but it is not required that both the second terminal and the first terminal complete network access.

302: The second terminal receives or sends, by using a radio channel, data according to the radio channel parameter.

More specifically, in step 300, the second terminal receives a downlink radio channel parameter sent by the first terminal. In this case, in step 302, the second terminal receives, by using a downlink radio channel, the data according to the downlink radio channel parameter, where the downlink radio channel parameter includes a carrier frequency, a timeslot number, and a modulation mode.

Alternatively, in step 300, the second terminal receives an uplink radio channel parameter sent by the first terminal. In this case, in step 302, the second terminal sends, by using an uplink radio channel, the data according to the uplink radio channel parameter, where the uplink radio channel parameter includes a carrier frequency, a timeslot number, and a modulation mode.

Description is given below by using that the second terminal receives the downlink radio channel parameter as an example.

The second terminal may periodically receive a data channel parameter sent by the first terminal, and receive, by using a data channel, the data according to the data channel parameter; or the second terminal receives, at a time, a control channel parameter sent by the first terminal, receives, by using a control channel, control information according to the control channel parameter, decodes the control information to obtain a data channel parameter, and receives, by using a data channel, the data according to the data channel parameter.

Optionally, the second terminal may receive, in the following manner, the downlink radio channel parameter sent by the first terminal:

exchanging identification information (for example, a device number) and negotiating a data encryption mode, by the second terminal, with the first terminal by using a data transmission link established between the second terminal and the first terminal, so that the first terminal sends, by using the data transmission link, the downlink radio channel parameter to the second terminal according to the identification information of the second terminal and the negotiated data encryption mode; and then receiving, by the second terminal, the downlink radio channel parameter by using the data transmission link.

Optionally, the second terminal may cooperate with the first terminal to perform data merging processing. For a detailed processing method, refer to a corresponding description in the embodiment shown in FIG. 2A and FIG. 2B, and details are not described herein.

According to the method provided in this embodiment of the present disclosure, the first terminal cooperates with the second terminal, so that the second terminal may download and upload data without accessing the wireless communications network. Therefore, both resource scheduling overheads and power consumption overheads are reduced.

In a specific implementation manner of the present disclosure, embodiments shown in FIG. 1A, FIG. 2A, FIG. 2C, and FIG. 3 may be applied to a wearable device. For example, the first terminal may be used as a control center (or referred to as a media data center) of personal communication of a user. The control center may be a communications module (for example, including only a baseband module, a control module, and a battery) having a large-capacity battery, or may be an intelligent terminal such as a smartphone or a PAD of the user. The control center manages a downlink data channel, and shares the downlink data channel with wearable devices such as smart glasses or a bone earphone. The control center and these wearable devices may simultaneously receive data by using a downlink channel, and feedback of channel information such as power control of the downlink channel may also be completed by the control center. Because the control center and the wearable device simultaneously receive data of a base station, a forwarding process in which the control center receives the data of the base station and then forwards the data to the wearable device is avoided, so that electricity consumption is reduced. Uplink data of the wearable device may be sent to the control center in a manner of short-range communication (human body communication, NFC, Bluetooth or Wi-Fi), and is forwarded to the base station by the control center. Such an uplink forwarding manner avoids power consumption that occurs when the wearable device directly sends data to a network base station (where power consumption of short-range communication from the wearable device to the control center is much less than the power consumption for sending the data to the base station), so that low power consumption of communication of the wearable device is achieved.

Due to a size limitation, it is not only difficult but also unnecessary to configure, for each wearable device, an ID (a SIM card) that can be identified by a network. It is a relatively feasible method to share an ID of the control center by using the method provided by the present disclosure (for example, a SIM card is s only the control center). In this way, communication traffic fees of all the wearable devices are all centralized at a SIM card account of the control center, and network air interface resources allocated by a public network all belong to the control center having the SIM card. Further, the control center may perform scheduling to determine a wearable device that uses the allocated air interface resource. An uplink air interface resource may include several allocation manners: use at a fixed time, a request priority-orientated manner, an alternate query manner, or the like. A wearable device to which a downlink air interface resource is allocated is determined according to a device of which a request is responded to by transferred content in the air interface resource. Therefore, a quantity of downlink resources is related to an uplink service request. As an air interface resource block unit for network allocation increases and quadrature amplitude modulation QAM increases, each resource block bears an increasingly large volume of data, and data of a same air interface resource block may be shared by multiple wearable devices.

It should be understood by a person skilled in the art that the present disclosure provides an innovative communication mode, where the mode is applied to a scenario in which multiple terminals (for example, at least two terminals) located in a range of close proximity simultaneously receive same data from a same base station, and is also applied to a scenario in which at least one terminal share a radio channel with another terminal to receive or send data, which can bring improvements in many aspects, for example, a signal-to-noise ratio of a received carrier is significantly improved, so that a transferring rate is improved or a bit error rate is reduced or a downlink transmit power is reduced; a network traffic sharing mechanism is provided to multiple users whose locations are centralized; a network transferring capability is improved, and average service traffic of a user can also be reduced by means of user sharing; it is beneficial to an application of a wearable device; it helps a user to build a platform suitable for multi-terminal communication; battery life of some terminals is improved; and so on.

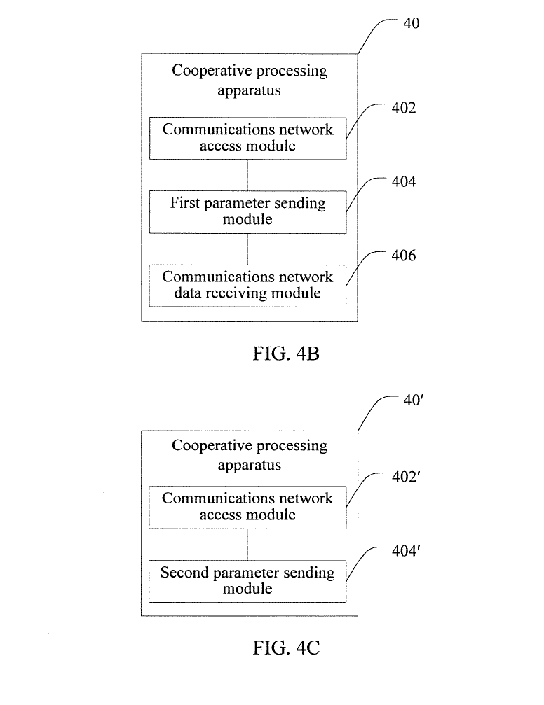

FIG. 4A is a schematic block diagram of an apparatus for cooperative processing of wireless data according to an embodiment of the present disclosure. Referring to FIG. 4A, the cooperative processing apparatus 40 includes:

a communications network access module 402, configured to access a wireless communications network; and a first parameter sending module 404, configured to send a downlink radio channel parameter to a second terminal, so that the second terminal receives, by using a downlink radio channel, data according to the downlink radio channel parameter, where the downlink radio channel parameter includes a carrier frequency, a timeslot number, and a modulation mode.

Optionally, in an implementation manner of this embodiment, the apparatus 40 further includes: a link establishment module, configured to establish a data transmission link to the second terminal; and a cooperative negotiation module, configured to exchange identification information and negotiate a data encryption mode with the second terminal by using the data transmission link. In this case, the first parameter sending module 404 may send, by using the data transmission link, the downlink radio channel parameter to the second terminal according to the identification information of the second terminal and the negotiated data encryption mode.

Optionally, in an implementation manner of this embodiment, the first parameter sending module 404 includes:

a first sending unit, configured to periodically send a data channel parameter to the second terminal, so that the second terminal receives, by using a data channel, the data according to the data channel parameter; or a second sending unit, configured to send a control channel parameter to the second terminal at a time, so that the second terminal receives, by using a control channel, control information according to the control channel parameter, and decodes the control information to obtain a data channel parameter, so as to receive, by using a data channel, the data according to the data channel parameter.

Optionally, in an implementation manner of this embodiment, referring to FIG. 4B, the cooperative processing apparatus 40 further includes: a communications network data receiving module 406, configured to receive, by using the downlink radio channel, the data according to the downlink radio channel parameter.

In this case, further optionally, the apparatus 40 further includes:

a summary data receiving module, configured to receive summary data sent by the second terminal, where the summary data includes demodulated data, decoded data, or data obtained after unpacking processing that is received by using the downlink radio channel by the second terminal; and a data merging processing module, configured to perform data merging processing according to the summary data and the data that is received by using the downlink radio channel by the communications network data receiving module, where a manner of the data merging processing is at least one of the following: data merging at a demodulated data layer, data merging at a decoded data layer, or data packet merging.

Alternatively, the apparatus 40 further includes:

a summary data sending module, configured to send summary data to the second terminal, so that the second terminal performs data merging processing according to the summary data and the data that is received by using the downlink radio channel by the second terminal, where the summary data includes demodulated data, decoded data, or data obtained after unpacking processing that is received by using the downlink radio channel by the communications network data receiving module, and a manner of the data merging processing is at least one of the following: data merging at a demodulated data layer, data merging at a decoded data layer, or data packet merging.

Optionally, in an implementation manner of this embodiment, the apparatus 40 further includes: a channel quality reporting module, configured to report a channel quality indicator CQI according to channel received quality of all terminals that receive the data by using the downlink radio channel, so that a base station allocates, on a subsequent radio frame, a radio resource to the first terminal with reference to the CQI.

FIG. 4C is a schematic block diagram of an apparatus for cooperative processing of wireless data according to an embodiment of the present disclosure. Referring to FIG. 4C, the cooperative processing apparatus 40′ includes:

a communications network access module 402′, configured to access a wireless communications network; and

a second parameter sending module 404′, configured to send an uplink radio channel parameter to the second terminal, so that the second terminal sends, by using an uplink radio channel, data according to the uplink radio channel parameter, where the uplink radio channel parameter includes a carrier frequency, a timeslot number, and a modulation mode.

The second parameter sending module 404′ may send the uplink radio channel parameter to the second terminal by using a data transmission link to the second terminal and a negotiated data encryption mode.

The cooperative processing apparatus 40 and the cooperative processing apparatus 40′ provided in the embodiments of the present disclosure can share a radio channel parameter with at least one second terminal, so that the second terminal may receive or send data by using a radio channel without accessing a wireless communications network. In addition, in some scenarios (for example, cooperative multimedia playing scenario), resource scheduling overheads and power consumption overheads can be reduced.

For detailed descriptions of a communication relationship between modules or units of the cooperative processing apparatus 40 or 40′, refer to corresponding descriptions in the method embodiments shown in FIG. 1, FIG. 2A, and FIG. 2C.

FIG. 5A is a schematic block diagram of an apparatus for cooperative processing of wireless data according to an embodiment of the present disclosure. Referring to FIG. 5A, the cooperative processing apparatus 50 includes (where a dotted-line box indicates that the module is optional):

a first parameter processing module 502, configured to receive a downlink radio channel parameter that is sent by a first terminal accessing a wireless communications network, and receive, by using a downlink radio channel, data according to the downlink radio channel parameter, where the downlink radio channel parameter includes a carrier frequency, a timeslot number, and a modulation mode.

Optionally, in an implementation manner of this embodiment, the first parameter processing module 502 includes: a first receiving unit, configured to periodically receive a data channel parameter sent by the first terminal; and a first processing unit, configured to receive, by using a data channel, the data according to the data channel parameter.

Alternatively, the first parameter processing module 502 includes: a second receiving unit, configured to receive, at a time, a control channel parameter sent by the first terminal; and a second processing unit, configured to receive, by using a control channel, control information according to the control channel parameter, decode the control information to obtain a data channel parameter, and receive, by using a data channel, the data according to the data channel parameter.

Optionally, in an implementation manner of this embodiment, the apparatus 50 further includes: a link establishment module, configured to establish a data transmission link to the first terminal; and a cooperative negotiation module, configured to exchange identification information and negotiate a data encryption mode with the first terminal by using the data transmission link, so that the first terminal sends, by using the data transmission link, the downlink radio channel parameter and an uplink radio channel parameter to the apparatus according to the identification information of the apparatus and the negotiated data encryption mode. In this case, the first parameter processing module 502 may receive the downlink radio channel parameter by using the data transmission link.

Optionally, in an implementation manner of this embodiment, the apparatus 50 further includes: a summary data sending module, configured to send summary data to the first terminal, so that the first terminal performs data merging processing according to the summary data and the data that is received by using the downlink radio channel by the first terminal, where the summary data includes demodulated data, decoded data, or data obtained after unpacking processing that is received by using the downlink radio channel by the first parameter processing module, and a manner of the data merging processing is at least one of the following: data merging at a demodulated data layer, data merging at a decoded data layer, or data packet merging.

Alternatively, the apparatus 50 further includes: a summary data receiving module, configured to receive summary data sent by the first terminal, where the summary data includes demodulated data, decoded data, or data obtained after unpacking processing that is received by using the downlink radio channel by the first terminal; and a data merging processing module, configured to perform data merging processing according to the summary data and the data that is received by using the downlink radio channel by the first parameter processing module, where a manner of the data merging processing is at least one of the following: data merging at a demodulated data layer, data merging at a decoded data layer, or data packet merging.

FIG. 5B is a schematic block diagram of an apparatus for cooperative processing of wireless data according to an embodiment of the present disclosure. Referring to FIG. 5B, the cooperative processing apparatus 50′ includes:

a second parameter processing module 502′, configured to receive an uplink radio channel parameter sent by the first terminal, and send, by using an uplink radio channel, the data according to the uplink radio channel parameter, where the uplink radio channel parameter includes a carrier frequency, a timeslot number, and a modulation mode.

The second parameter processing module 502′ may receive a radio channel parameter in a same manner as the first parameter processing module 502 does, for example, may include a link establishment module and a cooperative negotiation module.

Optionally, in an implementation manner of this embodiment, the cooperative processing apparatus 50′ sends, according to the received uplink radio channel parameter by using the uplink radio channel, data that needs to be uploaded by the cooperative processing apparatus 50′, or data that the cooperative processing apparatus 50′ receives from another terminal and that needs to be uploaded by the another terminal.

For detailed descriptions of functions of modules/units of the cooperative processing apparatus 50 and the cooperative processing apparatus 50′, refer to a corresponding description in the method embodiment shown in FIG. 3, and details are not described herein.

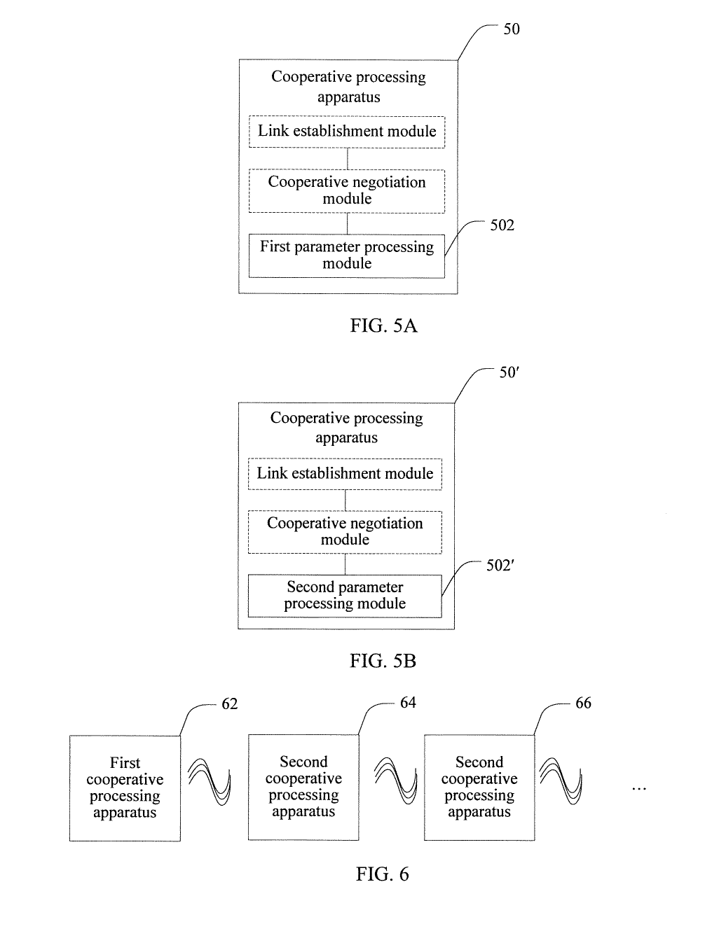

FIG. 6 is a schematic block diagram of a system for cooperative processing of wireless data according to an embodiment of the present disclosure. Referring to FIG. 6, the system includes a first cooperative processing apparatus 62 and at least one second cooperative processing apparatus, for example, includes second cooperative processing apparatuses 64 and 66. For a description of the first cooperative processing apparatus 62, refer to the foregoing descriptions of the cooperative processing apparatuses 40 and 40′, and for a description of the second cooperative processing apparatus, refer to the foregoing descriptions of the cooperative processing apparatuses 50 and 50′. For a description of a manner of communication between the first cooperative processing apparatus 62 and the second cooperative processing apparatus, refer to the descriptions in the method embodiments provided above, and details are not described herein. Certainly, more specifically, the system for cooperative processing of wireless data shown in FIG. 6 may include the cooperative processing apparatus 40 in the embodiment shown in FIG. 4A or FIG. 4B and the cooperative processing apparatus 50 in the embodiment shown in FIG. 5A, or include the cooperative processing apparatus 40′ in the embodiment shown in FIG. 4C and the cooperative processing apparatus 50′ in the embodiment shown in FIG. 5B.

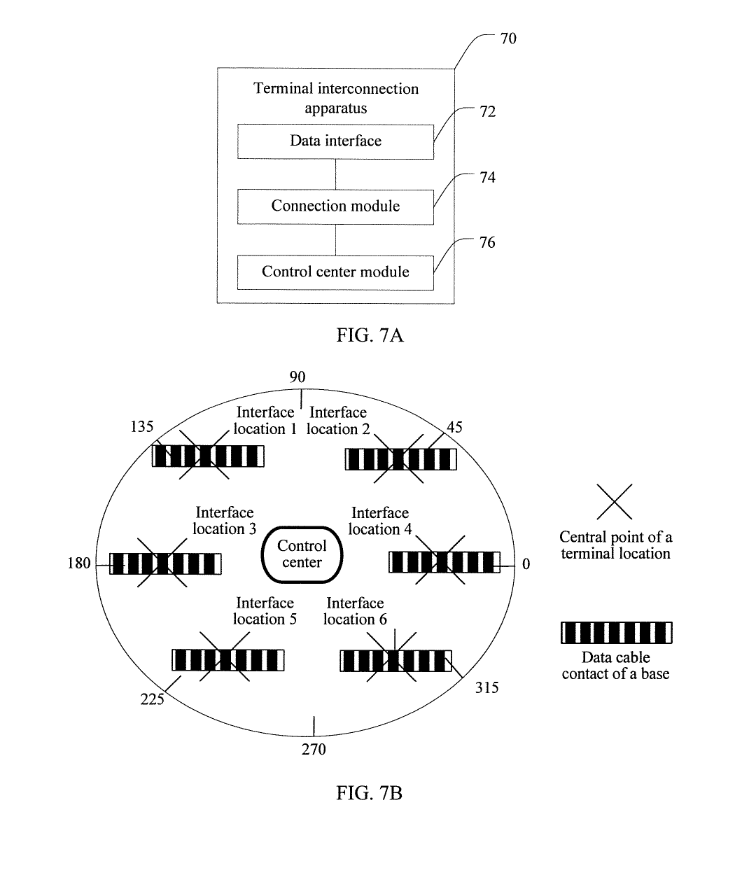

FIG. 7A is a schematic block diagram of a terminal interconnection apparatus according to an embodiment of the present disclosure, for an interconnection between cooperative processing apparatuses. Referring to FIG. 7, the terminal interconnection apparatus 70 includes:

a data interface 72, configured to establish a communication connection to a terminal, where optionally, the data interface may be a USB interface, and a quantity of data interfaces 72 is not limited in this embodiment, for example, the quantity may be one, two, or three to six, or a large number;

a connection module 74, configured to establish a communication connection (which may be a wired communication connection or may be a wireless communication connection) between the data interface and a control center module 76; and

the control center module 76, configured to access a wireless communications network, exchange identification information and negotiate a data encryption mode with a terminal on the data interface, and send an uplink radio channel parameter/a downlink radio channel parameter to the terminal on the data interface according to the identification information of the terminal on the data interface and the negotiated data encryption mode, so that the terminal on the data interface sends/receives data according to the uplink radio channel parameter/downlink radio channel parameter.

Optionally, in an implementation manner of this embodiment, the control center module 76 is further configured to receive, by using the connection module 74, summary data that is sent by the terminal on the data interface, where the summary data includes demodulated data, decoded data, or data obtained after unpacking processing that is received by using the downlink radio channel by the terminal on the data interface; and perform data merging processing according to the summary data, where a manner of the data merging processing is at least one of the following: data merging at a demodulated data layer, data merging at a decoded data layer, or data packet merging.

Optionally, in an implementation manner of this embodiment, the control center module 76 is further configured to receive, by using the connection module 74, data that needs to be uploaded and that is sent by the terminal on the data interface 72, and send, to a base station, the data needing to be uploaded.

FIG. 7B is a schematic diagram of a terminal interconnection apparatus according to an embodiment of the present disclosure. Interface locations (that is, data interfaces configured to establish communication connections to a terminal) are all in a wired communication connection or a wireless communication connection (not shown in the figure) to a control center. The control center may have all functions of the cooperative processing apparatuses 40 and 40′ shown in FIG. 4, or have all functions of the control center module 76 of the interconnection apparatus 70 shown in FIG. 7A, or the control center may be a terminal placed at an interface location. Numbers such as 45 and 90 in the figure represent angles at which the interface locations are located. In fact, the interface locations may be relatively fixed, or may be relatively movable. FIG. 7B is only a schematic diagram, and does not limit a specific layout of the terminal interconnection apparatus.

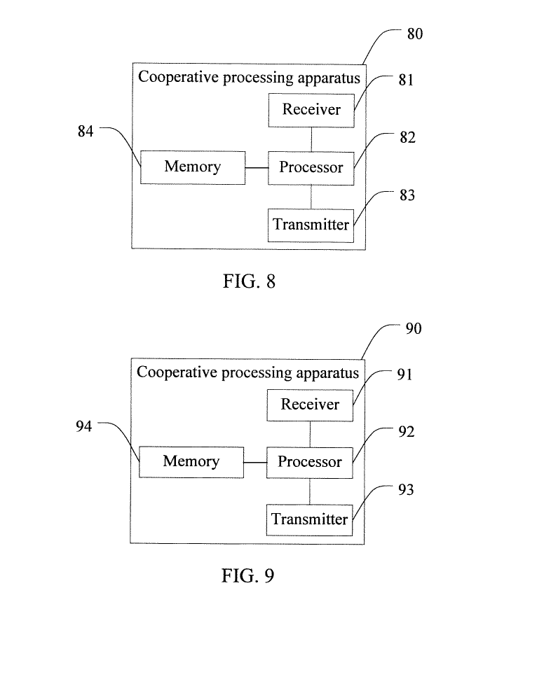

FIG. 8 is a schematic block diagram of a cooperative processing apparatus according to an embodiment of the present disclosure. Referring to FIG. 8, the cooperative processing apparatus 80 includes a receiver 81, a processor 82, a transmitter 83, and a memory 84. The processor 82 is separately connected to the receiver 81, the transmitter 83, and the memory 84; and the memory 84 is configured to store programs or applications, so that the processor 82 invokes the programs or applications to implement the following functions:

accessing a wireless communications network by using the receiver 81 and the transmitter 83; and

sending a downlink radio channel parameter to a second terminal by using the transmitter 83, so that the second terminal receives, by using a downlink radio channel, data according to the downlink radio channel parameter, where the downlink radio channel parameter includes a carrier frequency, a timeslot number, and a modulation mode; or

sending an uplink radio channel parameter to the second terminal by using the transmitter 83, so that the second terminal sends, by using an uplink radio channel, data according to the uplink radio channel parameter, where the uplink radio channel parameter includes a carrier frequency, a timeslot number, and a modulation mode.

Optionally, in an implementation manner of this embodiment, the processor 82 is further configured to:

exchange identification information and negotiate a data encryption mode with the second terminal by using a data transmission link established between the receiver 81 and the second terminal (for example, send a cooperative receiving request message to the second terminal by using the transmitter 83, and receive, by using the receiver 81, a response message fed back by the second terminal, and complete, by using the request message and the response message, exchanging of the identification information and negotiation of the data encryption mode); and

send, by using the data transmission link, the uplink/downlink radio channel parameter to the second terminal by using the transmitter 83 according to the identification information of the second terminal and the negotiated data encryption mode.

Optionally, in an implementation manner of this embodiment, the sending a downlink radio channel parameter to a second terminal by using the transmitter 83 includes: periodically sending, by the transmitter 83, a data channel parameter to the second terminal, so that the second terminal receives, by using a data channel, the data according to the data channel parameter; or sending, by the transmitter 83, a control channel parameter to the second terminal at a time, so that the second terminal receives, by using a control channel, control information according to the control channel parameter, and decodes the control information to obtain a data channel parameter, so as to receive, by using a data channel, the data according to the data channel parameter.

Optionally, in an implementation manner of this embodiment, after the sending the downlink radio channel parameter to the second terminal by using the transmitter 83, the processor 82 is further configured to receive, by using the downlink radio channel by using the receiver 81, the data according to the downlink radio channel parameter.

In this case, the processor 82 maybe configured to receive, by using the receiver 81, summary data sent by the second terminal, where the summary data includes demodulated data, decoded data, or data obtained after unpacking processing that is received by using the downlink radio channel by the second terminal; and perform data merging processing according to the summary data and the data that is received by using the downlink radio channel by the processor 82 by using the receiver 81, where a manner of the data merging processing is at least one of the following: data merging at a demodulated data layer, data merging at a decoded data layer, or data packet merging.

Alternatively, in this case, the processor 82 may be configured to: send summary data to the second terminal by using the transmitter 83, so that the second terminal performs data merging processing according to the summary data and the data that is received by using the downlink radio channel by the second terminal, where the summary data includes demodulated data, decoded data, or data obtained after unpacking processing that is received by using the downlink radio channel by a first terminal, and a manner of the data merging processing is at least one of the following: data merging at a demodulated data layer, data merging at a decoded data layer, or data packet merging.

Optionally, in an implementation manner of this embodiment, the processor 82 is further configured to: determine a channel quality indicator CQI according to channel received quality of all terminals that receive the data by using the downlink radio channel, and report the CQI by using the transmitter 83, so that a base station allocates, on a subsequent radio frame, a radio resource to the first terminal with reference to the CQI.

FIG. 9 is a schematic block diagram of a cooperative processing apparatus according to an embodiment of the present disclosure. Referring to FIG. 9, the cooperative processing apparatus 90 includes:

a receiver 91, a processor 92, a transmitter 93, and a memory 94, where the processor 92 is separately connected to the receiver 91, the transmitter 93, and the memory 94; and the memory 94 is configured to store programs or applications, so that the processor 92 invokes the programs or applications to implement the following functions:

receiving, by the receiver 91, a downlink radio channel parameter that is sent by a first terminal accessing a wireless communications network, and then receiving, by using a downlink radio channel, data according to the downlink radio channel parameter, where the downlink radio channel parameter includes a carrier frequency, a timeslot number, and a modulation mode; or

receiving, by using the receiver 91, an uplink radio channel parameter sent by the first terminal, and sending, by using an uplink radio channel, the data according to the uplink radio channel parameter, where the uplink radio channel parameter includes a carrier frequency, a timeslot number, and a modulation mode.

Optionally, in an implementation manner of this embodiment, that the processor 92 receives the downlink radio channel parameter by using the receiver 91 includes: periodically receiving, by the receiver 91, a data channel parameter sent by the first terminal, and then receiving, by the processor 92 by using a data channel, the data according to the data channel parameter; or receiving, by the receiver 91 at a time, a control channel parameter sent by the first terminal, and then receiving, by the processor 92 by using a control channel, control information according to the control channel parameter, decoding the control information to obtain a data channel parameter, and receiving, by using a data channel, the data according to the data channel parameter.

Optionally, in an implementation manner of this embodiment, the downlink radio channel parameter is received in the following manner: exchanging an ID and negotiating a data encryption mode with the first terminal by using a data transmission link established between the receiver 91 and the first terminal (for example, refer to a corresponding description in the embodiment shown in FIG. 8), so that the first terminal sends the downlink radio channel parameter to the cooperative receiving apparatus 90 according to an ID of at least one second terminal and the negotiated data encryption mode; and receiving, by the receiver 91, the downlink radio channel parameter by using the data transmission link.

Optionally, in an implementation manner of this embodiment, the processor 92 is further configured to: send summary data to the first terminal by using the transmitter 93, so that the first terminal performs data merging processing according to the summary data and the data that is received by using the downlink radio channel by the first terminal.

Optionally, in another implementation manner of this embodiment, the processor 92 is further configured to receive, by using the receiver 91, summary data sent by the first terminal, and then perform data merging processing according to the summary data and the data that is received by using the downlink radio channel by the receiver 91.

For detailed descriptions of the summary data and the data merging processing, refer to foregoing corresponding descriptions, and details are not described herein.

A person of ordinary skill in the art may understand that all or some of the processes of the methods in the embodiments may be implemented by a computer program instructing relevant hardware. The program may be stored in a computer readable storage medium. When the program runs, the processes of the methods in the embodiments are performed. The foregoing storage medium may include: a magnetic disk, an optical disc, a read-only memory (ROM), or a random access memory (RAM).

What is disclosed above is merely exemplary embodiments of the present disclosure, and certainly is not intended to limit the protection scope of the present disclosure. Any equivalent modification made in accordance with the claims of the present disclosure shall fall within the scope of the present disclosure.

What is claimed is:

1. A method for cooperative processing of wireless data, the method comprising:
accessing, by a first terminal, a wireless communications network; and
sending, by the first terminal, a downlink radio channel parameter to a second terminal, so that the second terminal receives, by using a downlink radio channel, data according to the downlink radio channel parameter, wherein the downlink radio channel parameter comprises a carrier frequency, a timeslot number, and a modulation mode; or
sending, by the first terminal, an uplink radio channel parameter to the second terminal, so that the second terminal sends, by using an uplink radio channel, data according to the uplink radio channel parameter, wherein the uplink radio channel parameter comprises a carrier frequency, a timeslot number, and a modulation mode.

2. The method according to claim 1, wherein sending, by the first terminal, a downlink radio channel parameter to a second terminal comprises:
periodically sending, by the first terminal, a data channel parameter to the second terminal, so that the second terminal receives, by using a data channel, the data according to the data channel parameter; or
sending, by the first terminal, a control channel parameter to the second terminal at a time, so that the second terminal receives, by using a control channel, control information according to the control channel parameter, and decodes the control information to obtain a data channel parameter, so as to receive, by using a data channel, the data according to the data channel parameter.

3. The method according to claim 1, wherein after sending, by the first terminal, a downlink radio channel parameter to a second terminal, the method further comprises:
receiving, by the first terminal by using the downlink radio channel, the data according to the downlink radio channel parameter.

4. The method according to claim 3, wherein after sending, by the first terminal, a downlink radio channel parameter to a second terminal, the method further comprises:
receiving, by the first terminal, summary data sent by the second terminal, wherein the summary data comprises demodulated data, decoded data, or data obtained after unpacking processing that is received by using the downlink radio channel by the second terminal; and
performing, by the first terminal, data merging processing according to the summary data and the data that is received by using the downlink radio channel by the first terminal, wherein a manner of the data merging processing is at least one of the following: data merging at a demodulated data layer, data merging at a decoded data layer, or data packet merging.

5. The method according to claim 3, wherein after sending, by the first terminal, a downlink radio channel parameter to a second terminal, the method further comprises:
sending, by the first terminal, summary data to the second terminal, so that the second terminal performs data merging processing according to the summary data and the data that is received by using the downlink radio channel by the second terminal, wherein the summary data comprises demodulated data, decoded data, or data obtained after unpacking processing that is received by using the downlink radio channel by the first terminal, and a manner of the data merging processing is at least one of the following: data merging at a demodulated data layer, data merging at a decoded data layer, or data packet merging.

6. The method according to claim 1, wherein the first terminal sends the downlink radio channel parameter to the second terminal in the following manner:
exchanging identification information and negotiating a data encryption mode, by the first terminal, with the second terminal by using a data transmission link established between the first terminal and the second terminal; and
sending, by the first terminal by using the data transmission link, the downlink radio channel parameter to the second terminal according to the identification information of the second terminal and the negotiated data encryption mode.

7. The method according to claim 3, further comprising:
reporting, by the first terminal, a channel quality indicator (CQI) according to channel received quality of all terminals that receive the data by using the downlink radio channel, so that a base station allocates, on a subsequent radio frame, a radio resource to the first terminal with reference to the CQI.

8. A method for cooperative processing of wireless data, the method comprising:
receiving, by a second terminal, a downlink radio channel parameter sent by a first terminal accessing a wireless communications network, and receiving, by using a downlink radio channel, data according to the downlink radio channel parameter, wherein the downlink radio channel parameter comprises a carrier frequency, a timeslot number, and a modulation mode; or
receiving, by the second terminal, an uplink radio channel parameter sent by a first terminal, and sending, by using an uplink radio channel, data according to the uplink radio channel parameter, wherein the uplink radio channel parameter comprises a carrier frequency, a timeslot number, and a modulation mode.

9. The method according to claim 8, wherein receiving, by a second terminal, a downlink radio channel parameter sent by the first terminal comprises:
periodically receiving, by the second terminal, a data channel parameter sent by the first terminal, and receiving, by using a data channel, the data according to the data channel parameter; or
receiving, by the second terminal at a time, a control channel parameter sent by the first terminal, receiving, by using a control channel, control information according to the control channel parameter, decoding the control information to obtain a data channel parameter, and receiving, by using a data channel, the data according to the data channel parameter.

10. The method according to claim 8, wherein the second terminal receives, in the following manner, the downlink radio channel parameter sent by the first terminal:
exchanging identification information and negotiating a data encryption mode, by the second terminal, with the first terminal by using a data transmission link established between the second terminal and the first terminal, so that the first terminal sends, by using the data transmission link, the downlink radio channel parameter to the second terminal according to the identification information of the second terminal and the negotiated data encryption mode; and
receiving, by the second terminal, the downlink radio channel parameter by using the data transmission link.

11. The method according to claim 8, wherein after receiving, by a second terminal, a downlink radio channel parameter sent by the first terminal, the method further comprises:
sending, by the second terminal, summary data to the first terminal, so that the first terminal performs data merging processing according to the summary data and the data that is received by using the downlink radio channel by the first terminal, wherein the summary data comprises demodulated data, decoded data, or data obtained after unpacking processing that is received by using the downlink radio channel by the second terminal, and a manner of the data merging processing is at least one of the following: data merging at a demodulated data layer, data merging at a decoded data layer, or data packet merging.

12. The method according to claim 8, wherein after receiving, by a second terminal, a downlink radio channel parameter sent by the first terminal, the method further comprises:
receiving, by the second terminal, summary data sent by the first terminal, wherein the summary data comprises demodulated data, decoded data, or data obtained after unpacking processing that is received by using the downlink radio channel by the first terminal; and
performing, by the second terminal, data merging processing according to the summary data and the data that is received by using the downlink radio channel by the second terminal, wherein a manner of the data merging processing is at least one of the following: data merging at a demodulated data layer, data merging at a decoded data layer, or data packet merging.

13. An apparatus for cooperative processing of wireless data, the apparatus comprising:
a communications network access unit, configured to access a wireless communications network; and
at least one of the following units:
a first parameter sending unit, configured to send a downlink radio channel parameter to a second terminal, so that the second terminal receives, by using a downlink radio channel, data according to the downlink radio channel parameter, wherein the downlink radio channel parameter comprises a carrier frequency, a timeslot number, and a modulation mode, and
a second parameter sending unit, configured to send an uplink radio channel parameter to the second terminal, so that the second terminal sends, by using an uplink radio channel, data according to the uplink radio channel parameter, wherein the uplink radio channel parameter comprises a carrier frequency, a timeslot number, and a modulation mode.

14. The apparatus according to claim 13, wherein the first parameter sending unit comprises:
a first sending unit, configured to periodically send a data channel parameter to the second terminal, so that the second terminal receives, by using a data channel, the data according to the data channel parameter; or
a second sending unit, configured to send a control channel parameter to the second terminal at a time, so that the second terminal receives, by using a control channel, control information according to the control channel parameter, and decodes the control information to obtain a data channel parameter, so as to receive, by using a data channel, the data according to the data channel parameter.

15. The apparatus according to claim 13, further comprising:
a communications network data receiving unit, configured to receive, by using the downlink radio channel, the data according to the downlink radio channel parameter.

16. The apparatus according to claim 15, further comprising:
a summary data receiving unit, configured to receive summary data sent by the second terminal, wherein the summary data comprises demodulated data, decoded data, or data obtained after unpacking processing that is received by using the downlink radio channel by the second terminal; and
a data merging processing unit, configured to perform data merging processing according to the summary data and the data that is received by using the downlink radio channel by the communications network data receiving unit, wherein a manner of the data merging processing is at least one of the following: data merging at a demodulated data layer, data merging at a decoded data layer, or data packet merging.

17. The apparatus according to claim 15, further comprising:
a summary data sending unit, configured to send summary data to the second terminal, so that the second terminal performs data merging processing according to the summary data and the data that is received by using the downlink radio channel by the second terminal, wherein the summary data comprises demodulated data, decoded data, or data obtained after unpacking processing that is received by using the downlink radio channel by the communications network data receiving unit, and a manner of the data merging processing is at least one of the following: data merging at a demodulated data layer, data merging at a decoded data layer, or data packet merging.

18. The apparatus according to claim 13, wherein:
the apparatus further comprises:
a link establishment unit, configured to establish a data transmission link to the second terminal, and
a cooperative negotiation unit, configured to exchange identification information and negotiate a data encryption mode with the second terminal by using the data transmission link; and
the first parameter sending unit sends, by using the data transmission link, the downlink radio channel parameter to the second terminal according to the identification information of the second terminal and the negotiated data encryption mode.

19. The apparatus according to claim 15, further comprising:
a channel quality reporting unit, configured to report a channel quality indicator (CQI) according to channel received quality of all terminals that receive the data by using the downlink radio channel, so that a base station allocates, on a subsequent radio frame, a radio resource to a first terminal with reference to the CQI.

20. An apparatus for cooperative processing of wireless data, the apparatus comprising:
a first parameter processing unit, configured to receive a downlink radio channel parameter sent by a first terminal accessing a wireless communications network, and receive, by using a downlink radio channel, data according to the downlink radio channel parameter, wherein the downlink radio channel parameter comprises a carrier frequency, a timeslot number, and a modulation mode; or
a second parameter processing unit, configured to receive an uplink radio channel parameter sent by a first terminal, and send, by using an uplink radio channel, data according to the uplink radio channel parameter, wherein the uplink radio channel parameter comprises a carrier frequency, a timeslot number, and a modulation mode.

21. The apparatus according to claim 20, wherein the first parameter processing unit comprises:
a first receiving unit, configured to periodically receive a data channel parameter sent by the first terminal; and
a first processing unit, configured to receive, by using a data channel, the data according to the data channel parameter.

22. The apparatus according to claim 20, wherein the first parameter processing unit comprises:
a second receiving unit, configured to receive, at a time, a control channel parameter sent by the first terminal; and
a second processing unit, configured to receive, by using a control channel, control information according to the control channel parameter, decode the control information to obtain a data channel parameter, and receive, by using a data channel, the data according to the data channel parameter.

23. The apparatus according to claim 20, wherein:
the apparatus further comprises:
a link establishment unit, configured to establish a data transmission link to the first terminal, and
a cooperative negotiation unit, configured to exchange identification information and negotiate a data encryption mode with the first terminal by using the data transmission link, so that the first terminal sends, by using the data transmission link, the downlink radio channel parameter to the first parameter processing unit according to the identification information of the apparatus and the negotiated data encryption mode; and
the first parameter processing unit receives the downlink radio channel parameter by using the data transmission link.

24. The apparatus according to claim 20, further comprising:
a summary data sending unit, configured to send summary data to the first terminal, so that the first terminal performs data merging processing according to the summary data and the data that is received by using the downlink radio channel by the first terminal, wherein the summary data comprises demodulated data, decoded data, or data obtained after unpacking processing that is received by using the downlink radio channel by the first parameter processing unit, and a manner of the data merging processing is at least one of the following: data merging at a demodulated data layer, data merging at a decoded data layer, or data packet merging.

25. The apparatus according to claim 20, further comprising:
a summary data receiving unit, configured to receive summary data sent by the first terminal, wherein the summary data comprises demodulated data, decoded data, or data obtained after unpacking processing that is received by using the downlink radio channel by the first terminal; and
a data merging processing unit, configured to perform data merging processing according to the summary data and the data that is received by using the downlink radio channel by the first parameter processing unit, wherein a manner of the data merging processing is at least one of the following: data merging at a demodulated data layer, data merging at a decoded data layer, or data packet merging.

26. A terminal interconnection apparatus, comprising:
a data interface configured to establish a communication connection to a terminal;
a connection unit, configured to establish a communication connection between the data interface and a control center unit; and
the control center unit, configured to access a wireless communications network, exchange identification information and negotiate a data encryption mode with a terminal on the data interface, and send an uplink radio channel parameter/a downlink radio channel parameter to the terminal on the data interface according to the identification information of the terminal on the data interface and the negotiated data encryption mode, so that the terminal on the data interface sends/receives data according to the uplink radio channel parameter/downlink radio channel parameter.

27. The apparatus according to claim 26, wherein the control center unit is further configured to:
receive, by using the connection unit, summary data that is sent by the terminal on the data interface, wherein the summary data comprises demodulated data, decoded data, or data obtained after unpacking processing that is received by using the downlink radio channel by the terminal on the data interface; and
perform data merging processing according to the summary data, wherein a manner of the data merging processing is at least one of the following: data merging at a demodulated data layer, data merging at a decoded data layer, or data packet merging.
